(19) United States
(12) Patent Application Publication
(10) Pub. No.: US 2020/0286109 A1
(43) Pub. Date: Sep. 10, 2020

(54) System and Method to Establish Value of Generated Leads and Opportunities in a Sales Process

(71) Applicant: Cien, Inc., Miami Beach, FL (US)

(72) Inventor: Robert F. Kall, Miami Beach, FL (US)

(73) Assignee: Cien, Inc., Miami Beach, FL (US)

(21) Appl. No.: 16/294,830

(22) Filed: Mar. 6, 2019

(51) Int. Cl. G06Q 30/02; G06Q 30/00; G06F 16/28; G06F 16/2457; G06F 17/18

(52) U.S. Cl. CPC G06Q 30/0204; G06Q 30/016; G06F 17/18; G06F 16/2457; G06F 16/285

(57) ABSTRACT

A system and method to establish value of generated leads and opportunities in a sales process, using data from a Customer Relationship Management (CRM) system. This is accomplished by breaking down the sales process in multiple steps. The method then establishes the probability of various leads generated by a marketing step and placing them in different bins. Then establishing the probability of turning said leads into opportunities during a prospecting process. The method then quantifies the original value of leads in the various bins and the incremental value generated by turning them into opportunities. The value generated by the sales person eventually closing the opportunity into revenue can be calculated by subtracting the value created in the previous steps in the sales process from the revenue of the specific sale.

### TECHNICAL FIELD

The present disclosure is generally related to sales systems, and more particularly to a value allocation system in a sales process.

### BACKGROUND

Companies with sales organizations rely heavily on customer relationship management (CRM). CRM systems uses data analysis to record and manage a company's interactions with current and future potential customers. This interaction is partly based on customer information such as names of potential contacts, customer geographical location, customer company structure, potential contact position in the customer company, potential needs of the customer, etc. This information along with actual sales data is usually stored in a CRM database that is part of an overall CRM system. The CRM system is a computer-based system with software that consolidates and compiles all customer information into a CRM database so that multiple users in a company can easily access and manage it. CRM systems have many functions including recording various customer interactions as well as automating various workflow processes including sales related tasks such as recording and tracking of information related to sales leads and sales cycles.

Existing CRM systems can automate and manage many different aspects of the sales cycle. One area that existing CRM systems cannot address however is the establishment of a value for the various aspects of a sales cycle as well as the value generated by each individual involved in those sales cycles. There is therefore a long felt need for a system and method that establishes the value of the generation of a sales lead and a sales opportunity in a sales process to discern value attribution.

### BRIEF DESCRIPTION OF THE DRAWINGS

The included drawings are for illustrative purposes and serve only to provide examples of possible structures and process operations for the disclosed inventive systems and methods for a value allocation system in a sales process. These drawings in no way limit any changes in form and detail that may be made by one skilled in the art without departing from the spirit and scope of the disclosed implementations.

FIG. 1 shows an embodiment of a system 10 for practicing embodiments of the instant invention.

FIG. 2 is a representation of a product sales cycle 90 according to an embodiment of the instant invention.

FIG. 3 is an arrangement for grouping the sales leads according to the probabilities of the leads grouped in bins B0 to Bn with sales leads with the lowest probability of resulting in an actual sale being grouped in bin B0.

FIG. 4(a) shows a flow chart for calculation of a boost constant used to determining the value created by individuals in a particular sales function.

FIG. 4(b) shows a flow chart for calculation of a the total economic value created by individuals in the prospecting function

FIG. 5 shows a system diagram the CRM data is constantly updated with data from the various sales functions 100, 110 and 120.

### DETAILED DESCRIPTION OF THE PREFERRED EMBODIMENTS

Selected embodiments of the instant invention will now be explained with reference to the drawings. It will be apparent to those skilled in the art that following descriptions of the various embodiments of the instant invention are provided for illustration only and not for the purpose of limiting the invention as described by the claims and their equivalents.

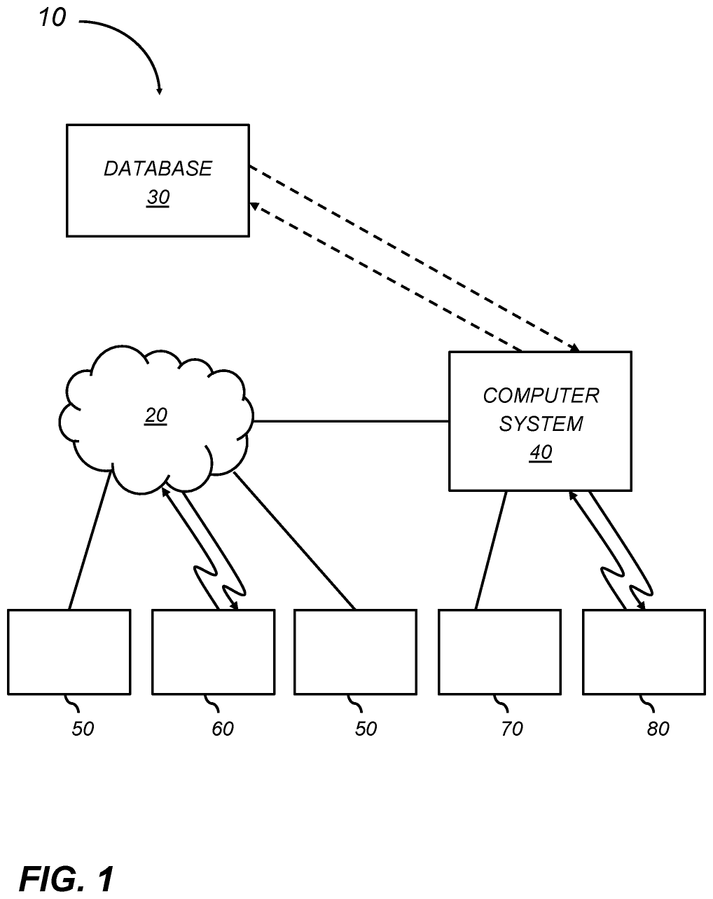

FIG. 1 shows an embodiment of a system 10 for practicing embodiments of the instant invention. In an embodiment this system can be implemented using the concept of cloud computing. In cloud computing the system provides shared resources, software, and information to computers and other devices upon request. In cloud computing environments, software can be accessible over the Internet rather than installed locally on in-house computer systems. Cloud computing typically involves over-the-Internet provision of dynamically scalable and often virtualized resources. In an embodiment the system 10 is “Multi-Tenant”, in that it handles multiple system customers using the same database, code and servers. The system 10 comprises a database 30 operably connected to a network 20. The database 30 comprises CRM data that is related to all aspects of a sales cycle with a given company. The network 20 can be a local area network (LAN), a wireless network, a star network, a point-to-point network, star hub network or any other network configuration. One of the most common networks in use today is the Internet. The Internet is a global system of interconnected computer networks that use the Internet protocol suite TCP/IP to link the devices on the network. The system 10 further comprises a computer system 40 that is operably coupled to the network 20 or alternatively can be operably connected to the database 30. In an embodiment of the instant invention the computer system 40 is an applications server with software programs configured to perform the method steps of the various embodiments of the instant invention. The computer system 40 comprises any number of processors, memory and software that allow the computer system to perform the functions further described in the instant disclosure. The computer system 40 can communicate with the database 30 (to among other things move data to and from the database 30) either through the network 20 or directly as shown in the Figure. The system 10 further comprises and a number of devices 50, 60, 70 and 80 through which users of the system 10 can practice the embodiments of the instant disclosure. These devices comprise devices 50 that are connected to network through addition networks and comprise processors, software and memory. Furthermore addition devices 60 (also comprising processors, software and memory) and be operably connected to the network through the use of a wireless protocol such as a wireless local area network (Wi-Fi) or through the use of a cellular network. In addition to the above described devices 50, 60 that are operably connected to computer system 40 through a network, devices 70 and 80 can be connected the computer system 40 without the network 20 as shown in FIG. 1. The device 70 can be connected to the computer system 40 through the use of a wired connection and the device 80 can be wirelessly connected to computer system 40 using wireless connectivity of the types described above (i.e. Wi-Fi and cellular).

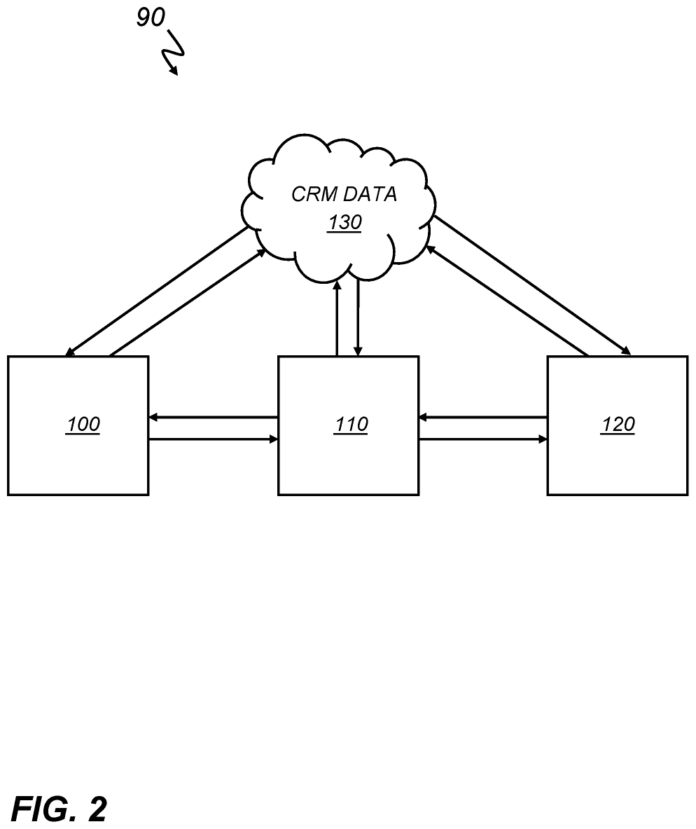

Shown in FIG. 2 is a representation of a product sales cycle 90 according to an embodiment of the instant invention. In this embodiment, the product sales cycle 90 is broken up into three functions 100, 110 and 120 although in the general case the product sales cycle can be described using any number of functions. For the embodiment shown in FIG. 2, the product sales cycle comprises a marketing function 100, a prospecting function 110 and a selling function 120. Each of these functions receives and provides CRM data 130 to and from a CRM database of the kind shown in FIG. 1. In a sales organization any number of individuals will be performing each function. In the marketing function 100 sales leads are generated. Sales leads represent potential customers each with various attributes that will be described in more detail below. At any given time the sales leads represent the group of potential customers to whom products and/or services can be eventually sold. These sales leads are fed into the prospecting function 110 where they are used by the individuals in the prospection function 110 to create opportunities. Opportunities are potential sales where a specific need has been established. In an embodiment, an opportunity represents a potential sale where a prospective customer has been engaged (e.g., the customer is willing to attend a sales meeting) and a monetary value of a potential deal can be estimated. As further shown in FIG. 2, opportunities will be fed into the selling function 120 where the individuals in the selling function can potentially close the opportunities into actual sales resulting in revenue to the sales organization. A sales deal will typically have components of a sales lead that becomes an opportunity leading to an actual sale. Each sales lead, opportunity and actual sale has an associated data record in the CRM data and this data record is continuously updated during the product sales cycle 90.

In the product sales cycle 90 it is important to be able to determine the value generated or lost by each of the functions 100, 110 and 120 as well as determining the value generated by each individual involved in the various sales functions 100, 110 and 120. It allows the user of the systems and methods of the various embodiments of the instant invention to discern the relative value generated or lost by each individual and in the aggregate by each of the sales functions 100, 110 and 120. This allows for determination of the value added by each job function as well as the optimization of the resource allocation in a sales organization.

Referring to the system shown in FIG. 1, existing CRM data is loaded into a computer system 40 from an existing CRM database 30. The CRM data can be transferred through a network 20 or directly from the database 30 to the computer system 40. This transfer can be initiated through anyone of the various devices 50, 60, 70 80 configured as a part of the system 10. In an embodiment the loading of the CRM data is accomplished through the use of a TCP/IP network. In the computer system 40 the CRM data is analyzed and categorized according to the product sales cycle 90 shown in FIG. 2. Under the marketing function 100 sales leads are grouped and analyzed in the computer system 40. As described above, sales leads are CRM data entries representing potential customers each with various attributes. At any given time the sales leads represent the group of potential customers to whom products and/or services can be eventually sold. Each sales lead data entry will have a list of associated attributes such as name of a contact, geographic location of potential customer, the business area of the potential customer, the company size of the potential customer, the position of the contact within the potential customers company, the industry, etc. In addition, the sales lead will have associated information about the individual in the marketing function 100 that generated the sales lead.

As described above, opportunities are potential sales where a specific need has been established. In an embodiment, an opportunity represents a potential sale where a prospective customer has been engaged (e.g., the customer is willing to attend a sales meeting) and a monetary value of a potential deal can be established. Under the prospecting function 110 CRM data entries representing the opportunities are grouped and analyzed by the computer system 40. Associated with the opportunities is a potential value and the information about the individual in the prospecting function 110 associated with the opportunity. Opportunities can be closed into actual sales resulting in revenue to the sales organization. Under the selling function 120 CRM data entries representing the actual sales are grouped and analyzed by the computer system 40. Associated with each actual sale is revenue obtained and the individual in the selling function 120 associated with the sale.

In an embodiment for a given set of CRM data representing related sales leads, opportunities and actual sales the computer system 40 will determine the average revenue per actual sale (ARS). The CRM data used in determining the ARS is typically sales data representing a given number of actual sales (AS) for a given period of time. For total revenue (RT) obtained from the number of actual sales AS, ARS is determined by the computer system 40 from loaded CRM data to be:

$$A R S = \frac{R T}{A S} \qquad ( i )$$

For example, if $100,000 is obtained from 100 actual sales then the average revenue per sale will be $1,000. For a total number of sales leads (TSL) that results in AS actual sales during the product sales cycle 90, an average probability (P_{ave 0}) for a sales lead resulting in an actual sale can be determined from the CRM data using the computer system 40 as,

$${P}_{a v e 0} = \frac{A S}{T S L} \qquad ( ii )$$

Again, by way of example, if 100 sales leads results in 2 actual sales then the average probability of a sales lead resulting in an actual sale is 2%. As stated earlier, the sales leads are produced in the marketing function 100 by individuals working in that function. The sales lead data can be obtained through multiple sources such as verbal communication, the Internet, email advertising and telephone marketing. Due to the varying nature of the sales leads not all sales leads will have the same probability of resulting in an actual sale. The probability of a sales lead leading to an actual sale can be computed based on the attributes associated with the sales lead. In an embodiment the probability of a sales lead leading to an actual sale can be computed as a machine learning prediction based on the attributes associated with the sales lead. Attributes such as geographic location of potential customer, the business area of the potential customer, the company size of the potential customer, the position of the contact within the potential customers company, the industry, the way the lead was obtained, etc., will all affect the probability that a sales lead will result in an actual sale. For example, a sales lead for a potential customer located in the same geographical location as the sales organization whose business aligns very well with the products and/or services of the sales organization will have a relatively high probability to result in an actual sale. This is compared to a sales lead where the potential customer is not located in the same geographical location as the sales organization, and whose business does not align well with the products and/or services of the sales organization. The latter sales lead will have a relatively low probability of resulting in an actual sale. The process attempts to match the average probability of a sales lead resulting in an actual sale (P_{ave 0}) with the actual recorded percentage of sales leads resulting in an actual sale in the customer's organization. Each individual sales lead in the CRM data base can be assigned a probability of resulting in a closed sale (P₀). This probability can be determined in any number of ways including the methods described above.

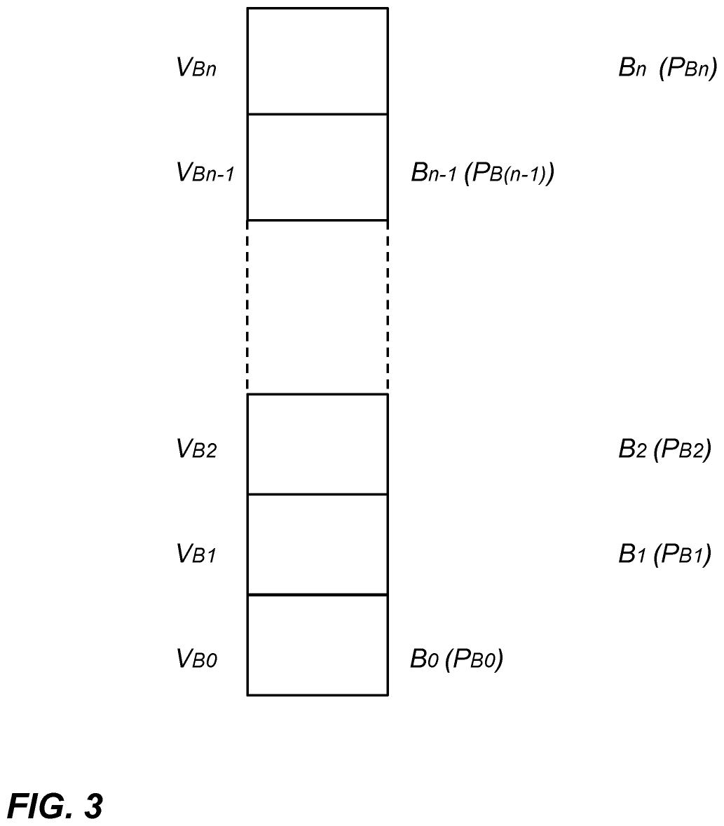

Shown in FIG. 3 is an arrangement for grouping the sales leads according to the probabilities of the leads resulting in an actual sale for an embodiment of the instant invention. The sales leads can be grouped in bins B0 to Bn with sales leads with the lowest probability of resulting in an actual sale being grouped in bin B0. Sales leads with the highest probability of resulting in an actual sale will be grouped in bin Bn and the remaining sales leads will be grouped in the remaining bins according to the probabilities assigned to the sales leads and the ranges of probability values assigned to each bin. In an embodiment the probability ranges defining the bins are determined based on the customer's distribution of P₀ to ensure some sales leads in the top bin. A very low probability threshold is set for sales leads in the lowest bin (typically less than 0.5%) so sales leads that are very unlikely to result in an actual sale are segmented from other leads.

Any number of bins can be used to group the sales lead data. In an embodiment of the instant invention 5 bins are used to group the sales leads. In a further embodiment greater than 5 bins are used to group the sales leads and in a further embodiment less than 5 bins are used to group the sales leads. Each of the bins shown in FIG. 3 represents a range of probabilities and sales leads with probabilities P₀ that fall within the probability range of a given bin will be grouped in that bin. For each bin a single probability related to the range of probabilities for that bin can be determined. These probabilities are shown in FIG. 3 as PB0, PB1, PB2 through PBn for the determined probabilities for bins B0, B1, B2 through Bn respectively. In an embodiment the bin probabilities PB0, PB1, PB2 through PBn are the average probabilities for the bins B0, B1, B2 through Bn respectively. In a further embodiment the bin probabilities PB0, PB1, PB2 through PBn are the mean probabilities for the bins B0, B1, B2 through Bn respectively. In general any method can be used to determine the single probability of each bin.

In a given sales organization each of the sales functions 100, 110 and 120 shown in FIG. 2 can be assigned a function overall value allocation (OVA). The OVA can be expressed as a percentage and represents the percentage of revenue that the sales organization assigns to each function. An example of an OVA for the three sales functions shown in FIG. 3 is 20%, 30% and 50% for the sales functions 100, 110 and 120 respectively. For this overall value allocation, if the sales organization generates $1,000 then $200 of value will be assigned to the overall marketing function 100, $300 of value will be assigned to the overall prospecting function 110 and $500 of value will be assigned to the overall selling function.

As shown in FIG. 3 monetary values VB1, VB2, VB3 through VBn are assigned to each bin B0 through Bn. In general any method can be used to assign the monetary values to each bin. In an embodiment these monetary values VB1, VB2, VB3 through VBn can be determined as follows. For an average revenue per sale ARS, a single bin probability PB and a function overall valuation OVA, the monetary value assigned to a bin is given as,

V_{B}=ARS×OVA×PB (iii)

In a given sales organization if the average value per sale is $5,000 and the sales organization has assigned an OVA of 20% to the marketing function, then for a bin with a single probability of 5% the monetary value VB assigned to that bin would be $50. Each sales lead that is grouped in that bin based on its probability would then be assigned a monetary value of $50. In the general case each sales lead grouped in a particular bin will be assigned the monetary value VB determined for that bin. The monetary value VB becomes a part of the data record for that sales lead in the CRM database. Each sales lead also has as a part of the data record related to the individual in the marketing function associated with that sales lead. The value created by an individual in the marketing function 100 can be determined by summing the monetary values of all the sales leads associated with that individual. Therefore, for an individual in the marketing function, the value created by that individual VMI is given as a sum of the value of all the sales leads created by that individual as follows,

V_{MI}=Σᵢ₌₁^{L} V_{B} (iv)

where L is the total number of sales leads associated with the individual in the marketing function. As sales leads are generated in the marketing function, each sales lead will have attributes as described earlier. These attributes will allow a probability to be assigned to the sales lead Po that represents the probability that the sales lead will result in an actual sale. In an embodiment this probability can be determined using machine learning. The probability assigned to the sales lead will allow the sales lead to be grouped in a bin with a probability range and a single representative probability. In an embodiment this single probability can be calculated as an average over all the probability values of each bin. Each bin will also have a monetary value and that monetary value will be assigned to the sales leads grouped in that particular bin. The overall value of the marketing function is the sum of the monetary values of all the sales leads and the value created by each individual in the marketing function is the sum of the monetary values of the sales leads associated with that individual. In an embodiment, using machine learning and statistical methods the computer system 40 will continuously re-evaluate the probability factors associated with the attributes of the sales leads and continuously improve the accuracy of the probabilities assigned to the sales leads as a function of the attributes of the sales leads.

As shown in FIG. 3 the sales leads developed in marketing function 100 will be fed into the sales function 110 and optionally the CRM data 130 can be updated with the sales lead data. In an embodiment the sales function 110 is the prospecting function and individuals in this function will take the incoming sales leads and try and convert them into opportunities. In an embodiment, an opportunity represents a potential sale where a prospective customer has been engaged (e.g., the customer is willing to attend a sales meeting) and a potential monetary value (PMV) of a potential deal can be established. For the sales individuals in the prospecting function 110 a sales lead that is assigned to an individual that the individual then fails to convert to an opportunity with a PMV represents a loss to the sales organization that is associated with that individual equal to the value of the sales lead that the individual failed to convert into an opportunity. Sales leads that are converted to opportunities represent an economic gain to the sales organization and to the individual that converted the opportunity from the sales lead. A probability can be determined P₁ that represents the probability that a sales lead is converted into an opportunity. Any method can be used to determine this probability. In an embodiment machine learning can be used to determine the probability P₁. In addition some of these opportunities will result in an actual (closed) sale. A probability P₂ can be determined that represents the probability that an opportunity results in an actual sale. Any general method can be used to determine this probability. In an embodiment machine learning can be used to determine the probability P₂. In an embodiment for a given sales lead, P₀=P₁×P₂, where P₁ is the probability that the given sales lead converts to an opportunity and P₂ is the probability that the opportunity converts to an actual (closed) sale.

In an embodiment a quantitative determination of the economic gain related to the development of opportunities in the prospecting function 110 begins with the determination of the PMV. In an embodiment this PMV can be determined through an estimation process or it can simply be assigned by individuals in the sales organization. In CRM data for a given sales organization there will be revenue recorded for a number of actual sales over a period of time. For these actual sales the CRM data will also contain data for sales leads and opportunities that led to the actual sales. Each opportunity in the CRM data will have a PMV associated with the CRM data record for the opportunity. For a given OVA for the prospecting function (OVAP) represented in the CRM data the value assigned to the prospecting function (PFV) by the sales organization can be determined as the revenue recorded multiplied by a boost factor multiplied by OVAP multiplied by the increase in the probability of the sales process resulting in an actual sale. In an embodiment this increase can be calculated as the difference between the machine learning prediction of the probability of the opportunity closing into an actual sale (P₂) and the sales lead that was converted into this opportunity resulting in an actual sale (P₀). The boost factor in turn is employed in order to assign more value to the individuals in prospecting function 110 for converting leads with lower probability of resulting in an actual sale than for converting leads with high probabilities of resulting in an actual sale. In an embodiment the boost factor it is based on the exponent of the inverse of the range limits used to determine the quality buckets described before and a boost constant x that must be fine-tuned in order to ensure that the sum of PMV for the opportunities will be the percentage of the total revenue recorded equal to total value generated by the individuals in the prospecting function 110. In an embodiment the value of the boost constant x can be any positive number (need to test many different possible values for range of x). In this way the boost constant can be constantly determined from the CRM data for different values of OVAP. In an embodiment the opportunity economic gain (OEG) for each opportunity developed in the prospecting function is given by

$${OEG}_{b} = PMV \times \frac{x}{{e}^{limit \_ b}} \times OVAP \times ( {P}_{2} - {P}_{0} ) \qquad ( v )$$

Where b is the sales lead quality bucket of the sales lead that was converted by an individual in the marketing function 100 into the opportunity, limit_b is the limit of the range defining the quality bucket that the corresponding sales lead belongs to and P₂ is the probability of the opportunity being closed into an actual sale. In an embodiment individuals in the prospecting function 110 will work on sales leads provided by marketing function 100 as shown in FIG. 2. These individuals will create opportunities from some of these sales leads and they will fail to convert other sales leads. Each individual in the prospecting function will create a net economic value to the sales organization given by the OEG sum for all the opportunities created by the individual minus the value of the sales leads for all sales leads lost by the individual (i.e. sales leads not converted to opportunities). The total value created to the sales organization for each individual in the prospecting function VPI is given by

VPI=Σᵢ OEG−Σ value of each sales lead lost by prospecting individual (vi)

where i is the number of opportunities created by the prospecting individual.

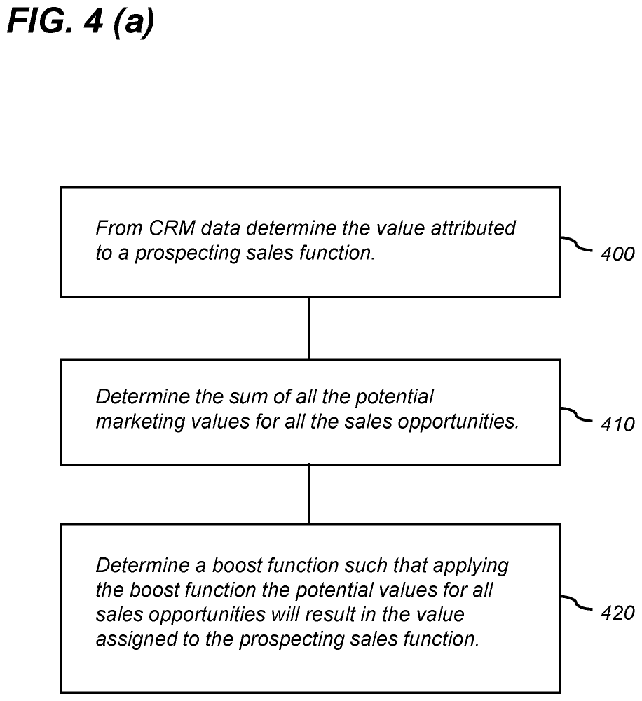

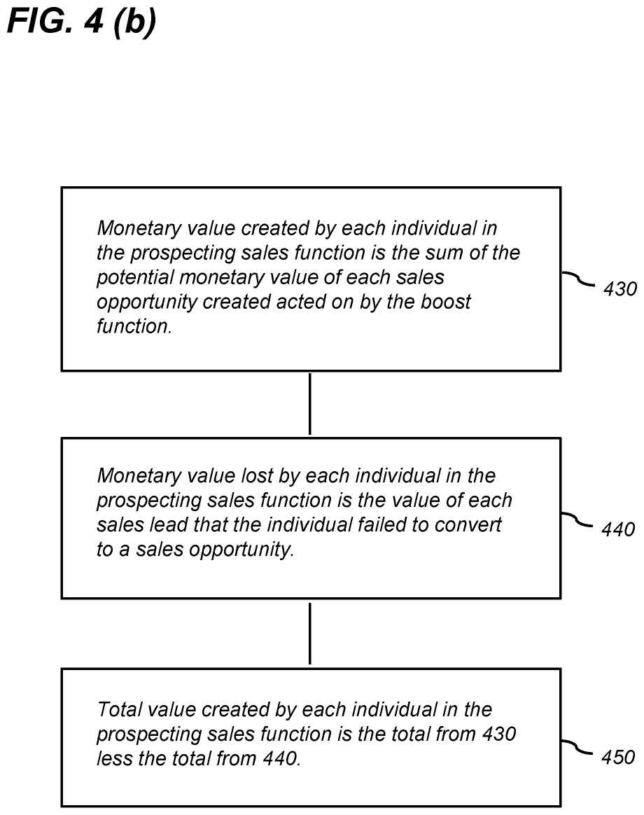

Shown in FIGS. 4(a) and 4(b) are flow charts for determining the value created by individuals in a particular sales function described above. In an embodiment the particular sales function is a prospecting sales function. The method begins with the determination of a boost constant shown in FIG. 4 (a). From existing CRM data, representing revenue obtained from a particular set of sales leads and the resulting sales opportunities and actual sales, determine the overall value assigned to the prospecting sales function by the sales organization 400. For all the sales opportunities in the particular CRM data set determine the sum of the potential monetary values for all the sales opportunities 410. Determine a boost constant such that applying the boost factor with this constant to the sum of the potential monetary values for all the sales opportunities will result in the value assigned to the prospecting function 420. This boost constant will be determined for a particular value assignment to the prospecting function. As shown in FIG. 4(b) the boost constant is determined and can be used on an ongoing basis to determine the economic value created by individuals in the prospecting function. The monetary value created by each individual in the prospecting function is the sum of the potential monetary value of each sales opportunity created by the individual less the value of the sales lead converted into that opportunity, acted upon by the boost constant 430. The monetary value lost by each individual in the prospecting function is the value of each sales lead that the individual failed to convert to a sales opportunity 440. The total value created by each individual in the prospecting function 450 is simply the total determined in 430 less the total determined in 440. In this way the monetary value created by each individual in the prospecting function can be determined periodically and on an ongoing basis as the sales opportunities are created and sales leads lost. As shown in FIG. 2 the CRM data can be updated with the monetary value generated by each individual in the prospecting function 110.

As shown in FIG. 2 the output from the prospecting function 110 is fed into the selling function 120. In an embodiment the sales opportunities developed in the prospecting function 110 are assigned to the sales individuals in the selling function 120. The individuals in the selling function 120 take the sales opportunities and try to close them into actual sales with an associated sales revenue booking value. For each sales opportunity that an individual in the selling function 120 closes to an actual sale with a booking value Vbooking, the monetary value to the sales organization created by that sales individual is Vbooking less the value of the sales opportunity that led to the actual sale. That value is equal to the booking value Vbooking less the boosted value added by the individual in the prospecting function 110 that created the opportunity less the value of the sales lead that led to the sales opportunity. For each sales opportunity that the individual in the selling function 120 fails to close to an actual sale the monetary loss to the sales organization created by the individual in the selling function is the value of the sales opportunity that led to the actual sale, which is equal to the boosted value created by the individual in the prospecting function 110 when creating the opportunity plus the value of the sales lead that led to this sales opportunity. For each sales individual in the selling function the total monetary value created for the sales organization is

Vsales=Σᵢ(Vbooking−OEG−V_{B})−Σᵢ(OEG−V_{B}) (vii)

where i is the total number of actual sales and j is the total number of sales opportunities that were not converted to actual sales. In this way the monetary value created by each individual in the selling function 120 can be determined periodically and on an ongoing base. As shown in FIG. 2 the CRM data can be updated with the monetary value generated by each individual in the selling function 120.

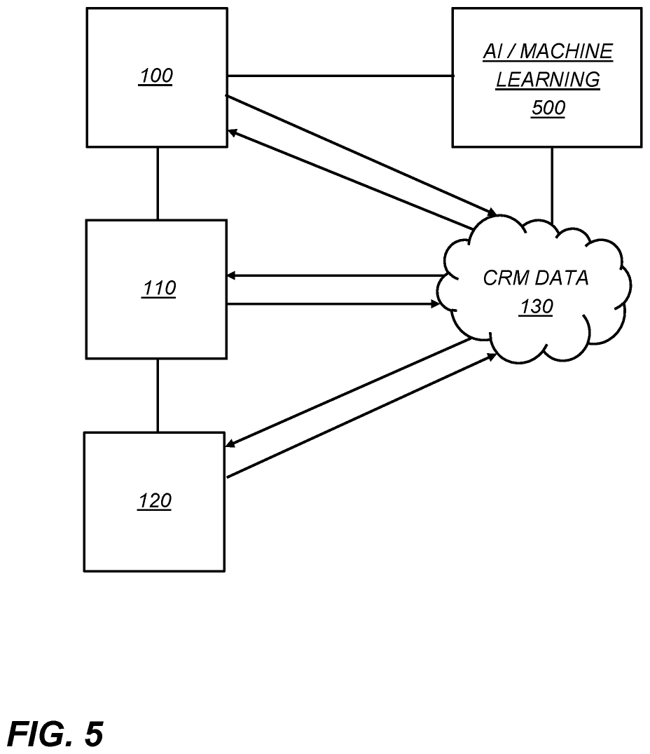

The various embodiments of the instant invention allows for the determination of the monetary value created in a sales organization by the individuals working in the various sales functions. Shown in FIG. 5 the three sales functions 100, 110 and 120 described previously. In determining the monetary value of the sales leads generated by individuals in the marketing function 100 various attributes were associated with each generated sales lead. These attributes were used to determine the probabilities associated with each sales lead becoming an actual sale. The probabilities were then used in a determination of the monetary value of each generated sales lead. As shown in FIG. 5 the CRM data is constantly updated with data from the various sales functions 100, 110 and 120. As more and more CRM data is generated regarding sales leads generated and the subsequent resulting actual sales, this data is used by a machine learning system 500 to adjust the probabilities associated with the various attributes associated with the generated sales leads. In this way the probabilities assigned to the generated sales leads will be updated to accurately reflect the changing environment in which the sales organization operates.

1. A method for determining a value of a sales lead, the method comprising:
assigning to a sales lead in a database a probability that the sales lead will result in a sale;
providing a plurality of bins in the database wherein each of said plurality of bins has a range of probabilities and a single probability related to the range of probabilities;
determining a monetary value for each of said plurality of bins wherein the monetary value is related to the single probability of each of plurality of bins;
grouping said sales lead in one of said plurality of bins where the probability assigned to the sales lead is within the range of probabilities of the one of said plurality of bins; and
determining the value of the sales lead wherein the value of the sales lead is the monetary value of the bin to which the sales lead is grouped.

2. The method of claim 1 wherein the determining of the monetary value for said plurality of bins further comprises:
determining an overall value allocation (OVA) for a sales function that generated the sales lead;
determining an average revenue per sale (ARS) for a plurality of sales resulting from sales leads for the sales function;
determining the monetary value for each of said plurality of bins by taking the product of the OVA and the ARS and the single probability for each of said plurality of bins respectively.

3. A method for determining the value of a sales function in a sales organization, the method comprising:
assigning to each sales lead in a database associated with a sales function a distinct probability for each sales lead resulting in a sale;
providing a plurality of bins in the database wherein each of said plurality of bins has a range of probabilities and a single probability related to the range of probabilities;
determining a monetary value for each of said plurality of bins wherein the monetary value is related to the single probability of each of plurality of bins;
grouping each of the sales leads in one of said plurality of bins wherein the probability assigned to the sales lead is within the range of probabilities of the one of said plurality of bins to which the sales lead is grouped in;
determining a value of each of the sales leads wherein the value of each of the sales leads is the monetary value of the bin to which the sales lead is grouped in; and
determining the value of the sales function as the sum of the monetary value of each of the sales leads.

4. The method of claim 3 wherein the determining of the monetary value for said plurality of bins further comprises:
determining an overall value allocation (OVA) for a sales function that generated the sales lead;
determining an average revenue per sale (ARS) for a plurality of sales resulting from sales leads for the sales function;
determining the monetary value for each of said plurality of bins by taking the product of the OVA and the ARS and the single probability for each of said plurality of bins respectively.

5. A method for determining a value created by an individual in a sales function, the method comprising:
assigning to each sales lead in a database associated with an individual in a sales function a distinct probability for each sales lead resulting in a sale;
providing a plurality of bins in the database wherein each of said plurality of bins has a range of probabilities and a single probability related to the range of probabilities;
determining a monetary value for each of said plurality of bins wherein the monetary value is related to the single probability of each of plurality of bins;
grouping each of the sales leads in one of said plurality of bins wherein the probability assigned to the sales lead is within the range of probabilities of the one of said plurality of bins to which the sales lead is grouped in;
determining a value of each of the sales leads wherein the value of each of the sales leads is the monetary value of the bin to which the sales lead is grouped in; and
determining the value created by the individual in the sales function as the sum of the monetary value of each of the sales leads.

6. The method of claim 5 wherein the determining of the monetary value for said plurality of bins further comprises:
determining an overall value allocation (OVA) for a sales function that generated the sales lead;
determining an average revenue per sale (ARS) for a plurality of sales resulting from sales leads for the sales function;
determining the monetary value for each of said plurality of bins by taking the product of the OVA and the ARS and the single probability for each of said plurality of bins respectively.
